(19) United States
(12) Patent Application Publication
(10) Pub. No.: US 2011/0057924 A1
(43) Pub. Date: Mar. 10, 2011

(54) DISPLAY DEVICE AND DRIVE CIRCUIT USED THEREFOR

(75) Inventor: Koushirou YANAI, Kanagawa (JP)

(73) Assignee: Renesas Electronics Corporation

(21) Appl. No.: 12/878,719

(22) Filed: Sep. 9, 2010

(30) Foreign Application Priority Data
Sep. 10, 2009 (JP) 2009-209101

(51) Int. Cl. G09G 5/00

(52) U.S. Cl. 345/212

(57) ABSTRACT

A drive circuit for driving data lines of a display panel in a display device is provided with grayscale voltage lines, a grayscale voltage supplying section, a DA converter circuit, an output voltage/precharge voltage switch circuitry and an output amplifier circuit. The grayscale voltage supplying section receives a plurality of reference voltages and a precharge voltage, and is configured to output a plurality of grayscale voltages generated from the reference voltages to the respective grayscale voltage lines and to selectively supply the precharge voltage to at least one of the grayscale voltage lines. The DA converter circuit receives the plurality of grayscale voltages, selects one of the plurality of grayscale voltages in response to a video signal and outputs the selected grayscale voltage. The output voltage/precharge voltage switch circuit is configured to selectively output the grayscale voltage received from the DA converter circuit or the precharge voltage received from the at least one grayscale voltage line, to corresponding one of the data lines of the display panel.

### INCORPORATION BY REFERENCE

This application claims the benefit of priority based on Japanese Patent Application No. 2009-209101, filed on Sep. 10, 2009, the disclosure of which is incorporated herein by reference.

### BACKGROUND OF THE INVENTION

1. Field of the Invention

The present invention relates to a display device and a drive circuit (hereinafter referred to as a source driver) for the display device, and more particularly, to a display device provided with precharge means.

2. Description of the Related Art

Liquid crystal display devices (LCD), which have advantages of thin dimension, light weight, and low power consumption, are widely spread, and frequently used for display parts of mobile devices such as cellular phones, PDAs (Personal Digital Assistant), and laptop computers. In particular, techniques for increasing in the screen size and dealing with video images in the liquid crystal display device are recently advanced, and therefore not only for a mobile use, but a floor-standing-type large screen display device, and a large screen liquid crystal television are also realized. As such liquid crystal display devices, active matrix driven liquid crystal display devices with high definition are used. In the following, a liquid crystal display device is taken as an example to provide a description.

First, a description is given of a typical configuration of the active matrix driven liquid crystal display device with reference to FIG. 17. It should be noted that, in FIG. 17, only major components of each pixel in the liquid crystal display panel are schematically illustrated with use of an equivalent circuit.

In general, a liquid crystal panel 6 of the active matrix driven liquid crystal display device includes: a transparent substrate on which transparent electrodes 64 and thin film transistors (TFTs) 63 are arranged in rows and columns (e.g., 1280×3 columns and ×1024 pixel rows for color SXGA (super extended graphics array)); an opposite substrate provided with one transparent opposite electrode 66 on the entire surface thereof. Liquid crystal material is filled between the two substrates opposed to each other. The turn-on and turn-off of the TFTs 63, which function as switches, are controlled by scan signals. When selected TFTs 63 are turned on, grayscale voltages specified by the video signal are applied to the corresponding pixel electrodes 64. The transmittance of the liquid crystal of each pixel varies on the potential difference between the corresponding pixel electrode 64 and the opposite electrode 66, and even after the TFT 63 is turned off, the potential is retained by a pixel capacitor 65 for a certain period of time to display an image.

On the transparent substrate, data lines 62 that send grayscale voltages to be applied to the respective pixel electrodes 64, and scan lines 61 that send scan signals are arranged in a grid form. The data lines 62 and the scan lines 61 serve as large capacitive loads due to the capacitors formed at intersections therebetween and pixels formed between the two substrates opposed to each other. For the color SXGA, the number of the data lines is 1280×3, and the number of the scan lines is 1024.

In addition, a gate driver 14 supplies the scan signals to the scan lines 61 from, and a source driver 11 supplies grayscale voltages the respective pixel electrodes 64 through the data line 62. Also, the gate driver 14 and the source driver 11 are controlled by a display controller 12, and respectively supplied with a required clock CLK, control signals (including a strobe signal STB which is generated from the horizontal synchronization signal) from the display controller 12, and the video signal is supplied to the source driver 11. Also, the power source voltage is supplied to the gate driver 14 and the source driver 11 from a power source circuit 13, and γ correction reference voltages, which are for γ correction, are supplied to the source driver 11 from the power source circuit 13.

Pixel data are rewritten at intervals of one frame period (which is typically 1/60 seconds, and for video images, may be 1/120 seconds). The scan lines are sequentially selected for the respective pixel rows, and the grayscale voltages for the pixels associated with the selected scan line are supplied from the source driver 11 through the data lines during the period of the selection.

It should be noted that the gate driver 14 is only required to supply the scan signals which are binary signals, whereas the source driver 11 is required to drive the data lines with many-level grayscale voltages corresponding to the number of grayscales. For this reason, the source driver 11 is provided with: a logic circuit that provides serial-parallel conversion for externally-inputted serial video signal to generate parallel image signals; a DA converter circuit (digital/analog conversion circuit) that converts the parallel image signals from the logic circuit into corresponding grayscale voltages; and an output amplifier circuit that outputs the grayscale voltages to the data lines 62.

Next, a description is given of the source driver 11 of the liquid crystal display device, which is provided with typical precharge means, with reference to FIG. 18, in connection with the present invention. It should be noted that FIG. 18 illustrates a portion of liquid crystal panel 6 of the liquid crystal display device in FIG. 17 for one pixel row.

In general, the term “precharge” refers to operation that applies a predetermined voltage to a data line immediately before a grayscale voltage is supplied to a pixel arranged on the liquid crystal panel 6. This effectively reduces the load on the output stage of the source driver 11, and thereby achieves further stable writing by suppressing variations in the load.

The source driver 11 in FIG. 18 is provided with: logic circuits 1 (1-1 to 1-N), DA converter circuits 3 (3-1 to 3-N); a positive grayscale voltage generator circuit 4a; a negative grayscale voltage generator circuit 4b; output amplifier circuits 5 (5-1 to 5-N) that output drive voltages corresponding to grayscale voltages received from the DA converter circuits 3; output voltage/precharge voltage switch circuits 2 (2-1 to 2-N) that selectively output the drive voltages outputted from the output amplifier circuits 5 or a precharge voltage (which is described later); and a cross switch circuitry 8 that switches the polarities of voltages outputted from the source driver 11 to the data lines 62 of the liquid crystal panel 6.

In large scale and high definition liquid crystal display devices, dot inversion driving is often used, which is a driving method in which the polarities of voltages applied to adjacent pixels are opposite. In this case, adjacent data lines 62 are driven with drive voltages of opposite polarities. The source driver 11 in FIG. 18 has a configuration adapted to the dot inversion driving. More specifically, the odd-numbered logic circuits 1, DA converter circuit 3 and output amplifier circuit 5 operate to generate positive drive voltages, whereas the even-numbered logic circuits 1, DA converter circuits 3, and output amplifier circuits 5 operate generate negative drive voltages. It should be noted that, in the Specification, the term “positive” means a higher voltage level than the voltage level of the opposite electrode 66 (hereinafter referred to as a “common level V_{COM}”), and the term “negative” means a lower voltage level than the common level V_{COM}.

Specifically, the logic circuits 1 latch video signals R, G, and B which have a predetermined number of bits (e.g., 8 bits) in synchronization with a strobe signal STB generated from the horizontal synchronization signal HSYNC, and outputs the latched video signals in parallel. The video signals outputted from the logic circuits 1 are supplied to the DA converter circuits 3. Also, the logic circuits 1 control the output voltage/precharge voltage switch circuit 2 as described later.

The positive grayscale voltage generator circuit 4a generates positive grayscale voltages V_{GS0}⁺ to V_{GS63}⁺ from positive γ correction reference voltages V1⁺ to V9⁺, and supplies the generated grayscale voltages V_{GS0}⁺ to V_{GS63}⁺ to the odd-numbered DA converter circuits 3. It should be noted that the γ correction reference voltages V1⁺ to V9⁺ are externally supplied reference voltages, and the grayscale voltages V_{GS0}⁺ to V_{GS63}⁺ are generated by further dividing the positive γ correction reference voltages V1⁺ to V9⁺ so as to be in accordance with the gamma curve of the liquid crystal panel 6. Similarly, the negative grayscale voltage generator circuit 4b generates negative grayscale voltages V_{GS0}⁻ to V_{GS63}⁻ from negative γ correction reference voltages V1⁻ to V9⁻, and supplies the generated grayscale voltages V_{GS0}⁺ to V_{GS63}⁺ to the even-numbered DA converter circuits 3. In general, the grayscale voltage generator circuits 4a and 4b each include a resistor ladder as shown in FIG. 19, for example.

The DA converter circuits 3 provide digital-analog-conversion for the video signals received from the logic circuits 1 to output analog grayscale voltages corresponding to the received video signals. Specifically, the odd-numbered DA converter circuits 3 select grayscale voltages corresponding to the video signals among from the grayscale voltages V_{GS0}⁺ to V_{GS63}⁺ generated by the positive grayscale voltage generator circuit 4a by using a decoder including a ROM switch and the like (not shown), and supplies the selected grayscale voltages to the odd-numbered output amplifier circuits 5. On the other hand, the even-numbered DA converter circuits 3 select grayscale voltages corresponding to the video signals received from the grayscale voltages V_{GS0}⁻ to V_{GS63}⁻ generated by the negative grayscale voltage generator circuit 4b, and supplies the selected grayscale voltages to the even-numbered output amplifier circuits 5.

The output amplifier circuits 5 each includes a voltage follower, and provide impedance conversion of the grayscale voltages supplied from the DA converter circuits 3 to generate the drive voltages. The generated drive voltages are outputted to the output voltage/precharge voltage switch circuit 2.

The output voltage/precharge voltage switch circuits 2 are configured to achieve precharging of the data lines 62 of the liquid crystal panel 6 in precharging operations. In a precharging operation, the output voltage/precharge voltage switch circuits 2 places the outputs of the output amplifier circuits 5 into the high impedance state, and outputs a precharge voltage VHC (positive constant voltage) or VLC (negative constant voltage) supplied from a precharge-dedicated voltage supply interconnections to the data lines 62 of the liquid crystal panel 6 through the cross switch circuitry 8. In writing the drive voltages onto the pixels of the liquid crystal panel 6, the output voltage/precharge voltage switch circuits 2 output the grayscale voltages received from the output amplifier circuits 5 to the data lines 62 of the liquid crystal panel 6 from the source driver 11 through the cross switch circuitry 8.

The cross switch circuitry 8 switches the polarities of the drive voltages outputted from the output voltage/precharge voltage switch circuit 2 to the liquid crystal panel 6 through odd and even output pads. The cross switch circuitry 8 outputs one of the positive drive voltage outputted from the odd-numbered output amplifier circuit 5 and the negative drive voltage outputted from the even-numbered output amplifier circuit 5 to an odd-numbered data line 62, and the other one to an even-numbered data line 62.

FIG. 20 is a diagram that shows a circuit portion for driving a pair of data lines 62 of the source driver 11 in FIG. 18. A positive-side drive block 9a, which is a circuit portion for generating a positive drive voltage, is provided with an odd-numbered logic circuit 1, a DA converter 3, an output amplifier circuit 5, and an output voltage/precharge voltage switch circuit 2 and is connected to an input terminal 21 of the cross switch circuitry 8. On the other hand, a negative-side drive block 9b, which is a circuit portion for generating a negative drive voltage, is provided with an even-numbered logic circuit 1, a DA converter 3, an output amplifier circuit 5, and an output voltage/precharge voltage switch circuit 2 and is connected to an input terminal 22 of the cross switch circuitry 8.

The positive-side drive block 9a is supplied with a precharge voltage VHC from outside the source driver 11, and the negative-side drive block 9b is supplied with a precharge voltage VLC. The precharge voltage VHC is supplied to the output voltage/precharge voltage switch circuit 2 of the positive-side drive block 9a through a precharge voltage supply line 51 (hereinafter referred to as a VHC line 51), and the precharge voltage VLC is supplied to the output voltage/precharge voltage switch circuit 2 of the negative-side drive block 9b through the precharge voltage supply line 52 (hereinafter referred to as a VLC line 52).

On the other hand, the cross switch circuitry 8 connects one of the input terminals 21 and 22 to an odd output pad 31, and the other one to an even output pad 32. It should be noted that the odd output pad 31 refers to an output pad connected to a corresponding odd-numbered data line 62, and the even output pad 32 refers to an output pad connected to a corresponding even-numbered data line 62. In performing the dot inversion driving, the polarities of the drive voltages outputted from the odd and even output pads 31 and 32 are switched every horizontal period and every frame by the cross switch circuitry 8.

Specifically, the cross switch circuitry 8 provides a connection between the odd output pad 31 and the cross switch input terminal 21, and a connection between the even output pad 32 and the cross switch input terminal 22 in a certain horizontal period. As a result, the positive drive voltage or the precharge voltage VHC is outputted from the odd output pad 31, and the negative drive voltage or the precharge voltage VLC is outputted from the even output pad 32. In the next horizontal period, the cross switch circuitry 8 provides a connection between the odd output pad 31 and the cross switch input terminal 22, and a connection between the even output pad 32 and the cross switch input terminal 21. As a result, the negative grayscale voltage or precharge voltage VLC is outputted from the odd output pad 31, and the positive grayscale voltage or precharge voltage VHC is outputted from the even output pad 32. In this manner, the grayscale voltages or the precharge voltages having different polarities are outputted from the adjacent output pads to the corresponding data lines 62 of the liquid crystal panel 6.

Next, a description is given of the operation of selectively outputting the precharge voltage or the drive voltage with reference to FIG. 21. Although the operation of the positive-side drive block 9a is described in the following, the person skilled in the art would, appreciate that the operation of the negative side block 9b is the same as that of the positive-side drive block 9a; the positive-side drive block 9a and the negative-side drive block 9b essentially have the same configuration, and the difference is that the polarities of the generated drive voltages are opposite with respect to the common level V_{COM}. It should be also noted that in the following, a description is given of the operation for a case where the cross switch circuitry 8 provides a connection between the output of the positive-side drive block 9a (that is the cross switch input terminal 21) and the odd output pad 31, and a connection between the output of the negative-side drive block 9b (that is, the cross switch input terminal 22) and the even output pad 32; however, the person skilled in the art would appreciate that the connections between the positive and negative side drive blocks 9a and 9b and the odd and even output pads 31 and 32 are not so substantial in selectively outputting the precharge voltage or the drive voltages.

As illustrated in FIG. 21, during precharging in a period T1, the switch 42 of the output voltage/precharge voltage switch circuit 2 is turned on and the switch 41 is turned off, in synchronization with a rise of the strobe signal STB. This allows outputting the precharge voltage VHC, which is approximately the average voltage between the highest grayscale voltage and the common level V_{COM}, from the odd output pad 31 of the source driver 11 to thereby precharge the corresponding data line 62 of the liquid crystal panel 6, which is connected to the odd output pad 31. Subsequently, during a period T2, the switch 42 is turned off in synchronization with a fall of the strobe signal STB, and the DA converter circuit 3 selects the grayscale voltage corresponding to the video signal. Then, during a period T3, the switch 41 is turned off with the switch 42 kept in the off state, and thereby the selected grayscale voltage is outputted from the odd output pad 31 of the source driver 11 to drive the data line 62 of the liquid crystal panel 6 with the desired grayscale voltage. Such operation allows the source driver 11, which is adapted to precharging, to operate quickly.

Conventional examples of such a source driver are disclosed in Japanese Patent Application Publications No. P2003-226353A and P2007-4109A, for example.

Meanwhile, a large liquid crystal display device is usually provided with multiple gate drivers 14 and source drivers 11 having the same functions; a configuration of one gate driver and one source driver cannot address a significant increase in the number of pixels.

In addition, a number of circuits are integrated within each source driver 11 to drive a number of data lines 62. That is, for each of the data lines 62 (for each output pad 31 or 32), one positive-side drive block 9a or one negative-side drive block 9b is provided. That is, the number of the drive blocks 9a and 9b is equal to the number of output pads 31 or 32. In this case, for simplicity of the circuit layout, the drive blocks 9a and 9b are aligned to the corresponding output pads 31 and 32. On the other hand, the positive grayscale voltage generator circuit 4a and the negative grayscale voltage generator circuit 4b are not provided for each drive block; the positive grayscale voltage generator circuit 4a and the negative grayscale voltage generator circuit 4b provides common references of the grayscale voltages for each of the drive blocks arranged in the entire of the integrated circuit, in order to reduce variations in the grayscale voltage among the drive blocks.

An arrangement example of the source driver 11 having such a configuration implemented in an integrated circuit is illustrated in schematic diagrams of FIGS. 22 to 24.

FIG. 22 is the schematic diagram illustrating a circuit arrangement of the source driver 11 illustrated in FIG. 18. It should be noted that the cross switch circuitry 8 is not illustrated in FIG. 22. The drive blocks 9a and 9b are regularly arrayed to be aligned to the output pads 31 and 32. FIG. 23 is an enlarged view of the portion A in FIG. 22, which schematically shows the outline of the circuit arrangement of the drive blocks 9a and 9b corresponding to a pair of the output pads 31 and 32 in the source driver 11. Further, FIG. 24 is an enlarged view of the part B in FIG. 22, which schematically shows the circuit portion around a VHC supply pad 33 and a VLC supply pad 34, which are used for externally supplying the precharge voltages VHC and VLC, and positive γ correction reference voltage pads 35 which are used for externally supplying the positive γ correction reference voltages V1⁺ to V9⁺.

As illustrated in FIG. 22, the positive grayscale voltage generator circuit 4a and the negative grayscale voltage generator circuit 4b are provided in the central portion of the integrated circuit. This is the optimum arrangement for supplying grayscale voltages generated by the grayscale voltage generator circuits 4a and 4b to the drive blocks 9a and 9b arranged at the edges of the integrated circuit with short interconnection lengths to reduce voltage drops as much as possible. Also, each of the drive blocks 9a and 9b is arranged adjacent to the corresponding one of the output pads 31 and 32. The precharge voltages VHC and VLC are, as illustrated in FIGS. 22 to 24, supplied from the VHC supply pad 33 and the VLC supply pad 34, and dedicated VHC and VLC lines 51 and 52, which have a wide width, are arranged between the output voltage/precharge voltage switch circuits 2 and the output amplifier circuits 5 so as to surround the internal circuits, such as the respective drive blocks 9a and 9b and the grayscale voltage generator circuits 4a and 4b.

One problem in the source driver of the conventional display device having the precharge function as illustrated in FIG. 22 is that the area where the precharge voltage supply lines used for supplying the precharge voltages to the respective output pads are arranges is large. The widths of the precharge voltage supply lines are inevitably increased for decreasing the interconnection resistances to prevent voltage drops. However, the use of the precharge voltage supply lines with increased interconnection widths undesirably causes an increase in the chip size of the source driver.

### SUMMARY

In an aspect of the present invention, a drive circuit for driving data lines of a display panel in a display device is provided with grayscale voltage lines, a grayscale voltage supplying section, a DA converter circuit, an output voltage/precharge voltage switch circuitry and an output amplifier circuit. The grayscale voltage supplying section receives a plurality of reference voltages and a precharge voltage, and is configured to output a plurality of grayscale voltages generated from the reference voltages to the respective grayscale voltage lines and to selectively supply the precharge voltage to at least one of the grayscale voltage lines. The DA converter circuit receives the plurality of grayscale voltages, selects one of the plurality of grayscale voltages in response to a video signal and outputs the selected grayscale voltage. The output voltage/precharge voltage switch circuit is configured to selectively output the grayscale voltage received from the DA converter circuit or the precharge voltage received from the at least one grayscale voltage line to corresponding one of the data lines of the display panel.

In another aspect of the present invention, a display device is provided with a display panel including pixels arranged in rows and columns; a display controller supplying a video signal; a power supply circuit supplying a plurality of reference voltages; a gate driver supplying scan signals to gate lines of the display panel; and a drive circuit responsive to the video signal for driving data lines of the display panel. The drive circuit includes: grayscale voltage lines; a grayscale voltage supplying section receiving the plurality of reference voltages and a precharge voltage and configured to output a plurality of grayscale voltages generated from the reference voltages to the respective grayscale voltage lines and to selectively supply the precharge voltage to at least one of the respective grayscale voltage lines; a DA converter circuit receiving the plurality of grayscale voltages, selecting one of the plurality of grayscale voltages in response to a video signal and outputting the selected grayscale voltage; an output voltage/precharge voltage switch circuit configured to selectively output the grayscale voltage received from the DA converter circuit or the precharge voltage received from the at least one grayscale voltage line, to corresponding one of the data lines of the display panel.

The present invention effectively reduces the area necessary to arrange lines for supplying precharge voltages.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram of a source driver in a first embodiment of the present invention;

FIG. 2 is a diagram illustrating the configuration of a portion corresponding to one output of the source driver in the first embodiment;

FIG. 3 is a timing chart illustrating the operation of the source driver of FIG. 2;

FIG. 4 is a timing chart illustrating the operation of the source driver for a case where the source driver is provided with charge sharing means in the first embodiment;

FIG. 5 is an arrangement example of the source driver of the first embodiment in an integrated circuit;

FIG. 6 is a schematic diagram of the part A of FIG. 5;

FIG. 7 is a schematic diagram of the part B of FIG. 5;

FIG. 8 is a diagram illustrating a configuration of a portion corresponding to one output of a source driver in a second embodiment of the present invention;

FIG. 9 is a diagram illustrating a variation of the configuration of the portion corresponding to the one output of the source driver in the second embodiment;

FIG. 10 is a diagram illustrating a variation of the configuration of a portion corresponding to one output of a source driver in a third embodiment of the present invention;

FIG. 11 is a block diagram of a source driver in a fourth embodiment of the present invention;

FIG. 12 is a diagram illustrating the configuration of a portion corresponding to one output of the source driver in a fourth embodiment;

FIG. 13 is an arrangement example of the source driver of the fourth embodiment in an integrated circuit;

FIG. 14 is a schematic diagram of a part C of FIG. 13;

FIG. 15 is a diagram illustrating a variation of the configuration of the portion corresponding to the one output of the source driver in the fourth embodiment;

FIG. 16 is a diagram illustrating another variation of the configuration of the portion corresponding to the one output of the source driver in the fourth embodiment;

FIG. 17 is a diagram illustrating a configuration of a liquid crystal display device;

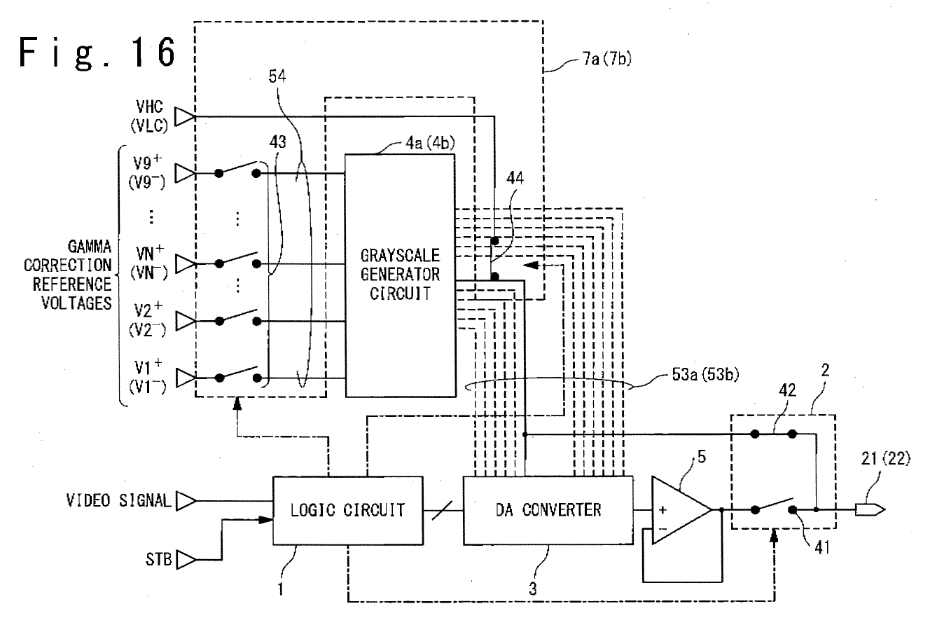

FIG. 16 is a block diagram of a conventional source driver provided with precharge means;

FIG. 19 is a diagram illustrating a configuration example of a grayscale voltage generator circuit;

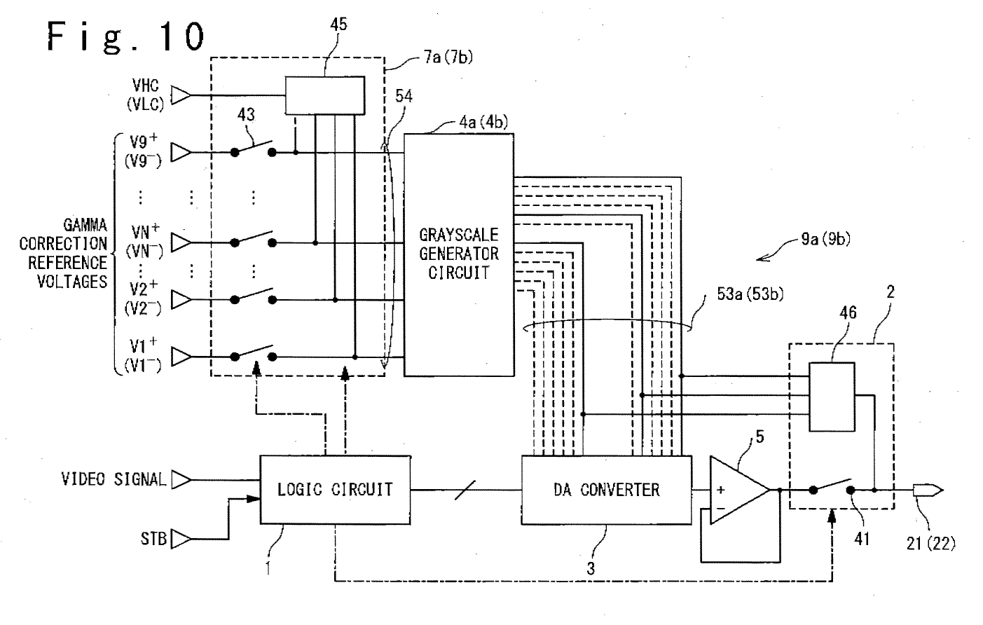

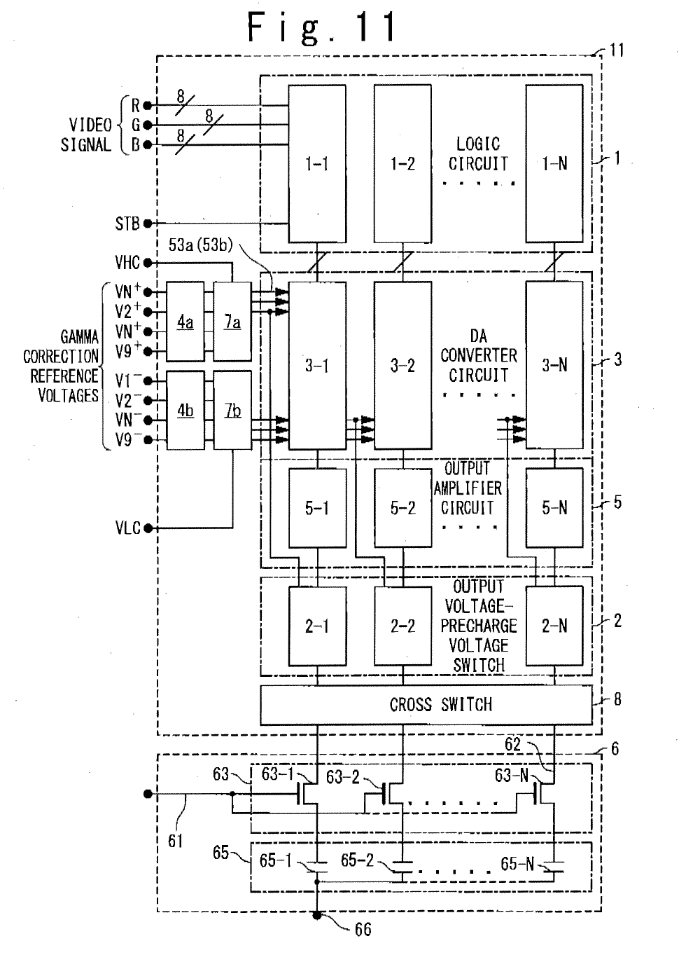

FIG. 20 is a diagram showing a portion corresponding to two outputs of the conventional source driver in FIG. 10;

FIG. 21 is a timing chart illustrating operation of the source driver of FIG. 20;

FIG. 22 is an arrangement example of the conventional source driver provided with the precharge means in an integrated circuit;

FIG. 23 is a schematic diagram of the part A in FIG. 22; and

FIG. 24 is a schematic diagram of the part B in FIG. 22.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

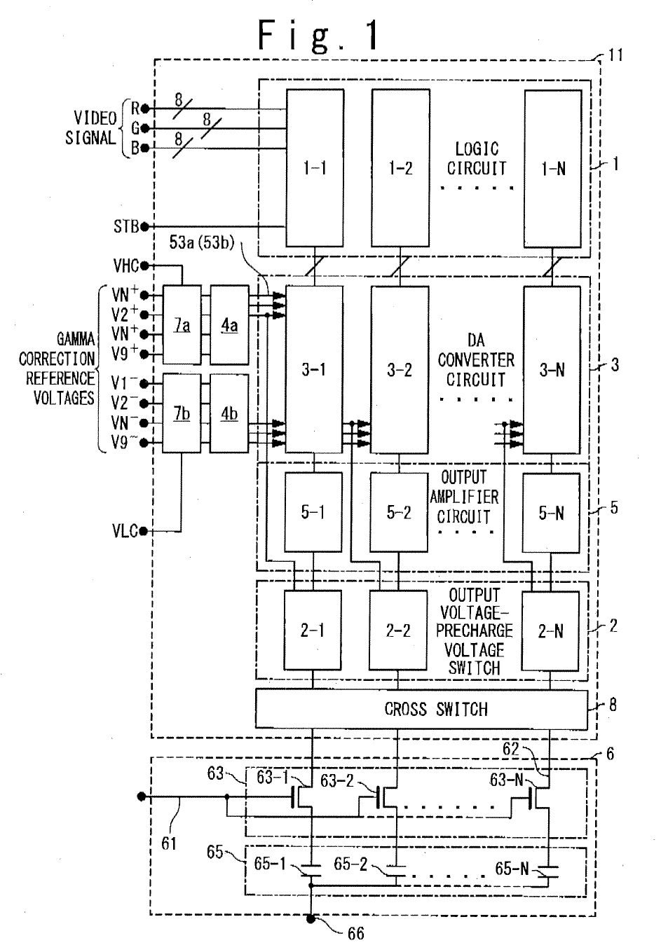

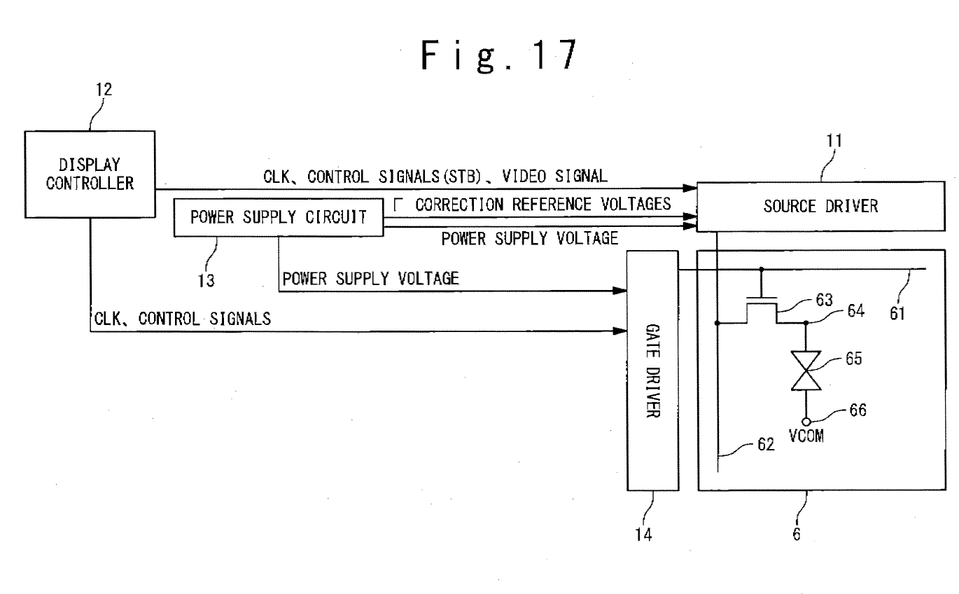

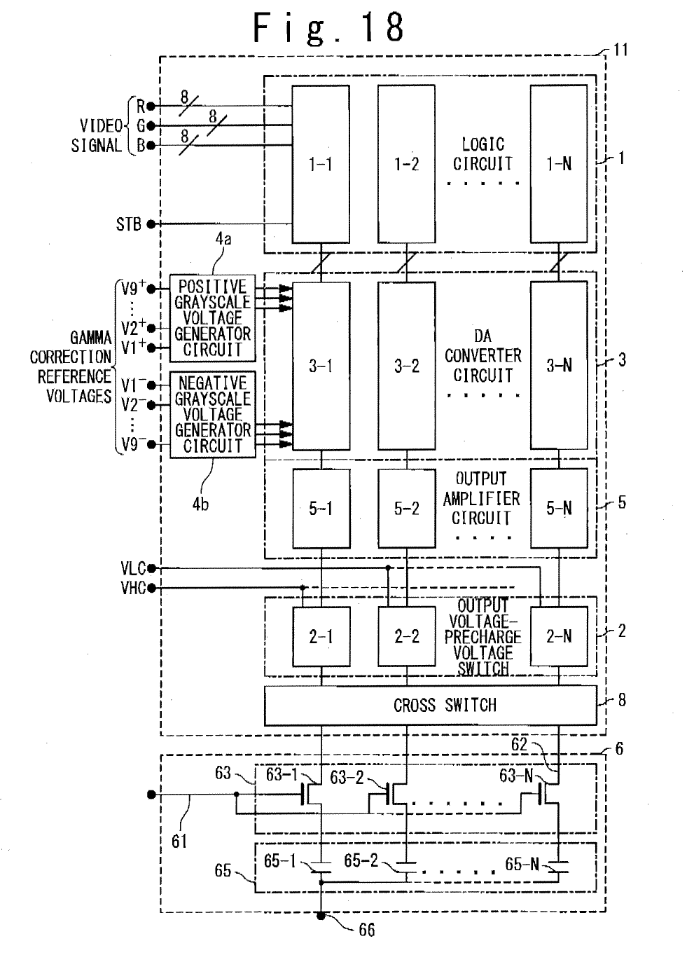

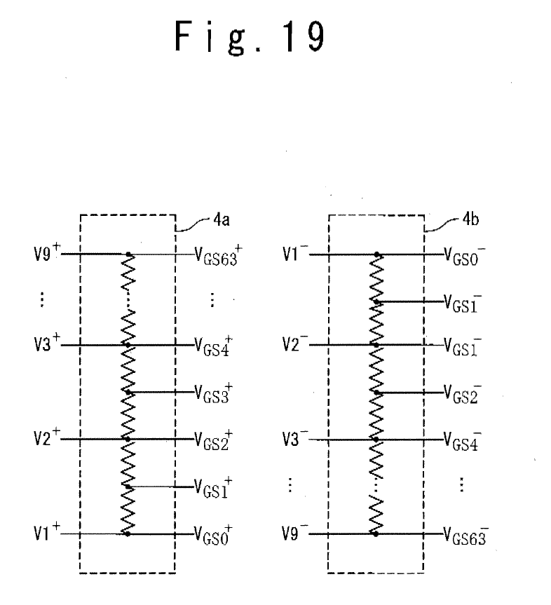

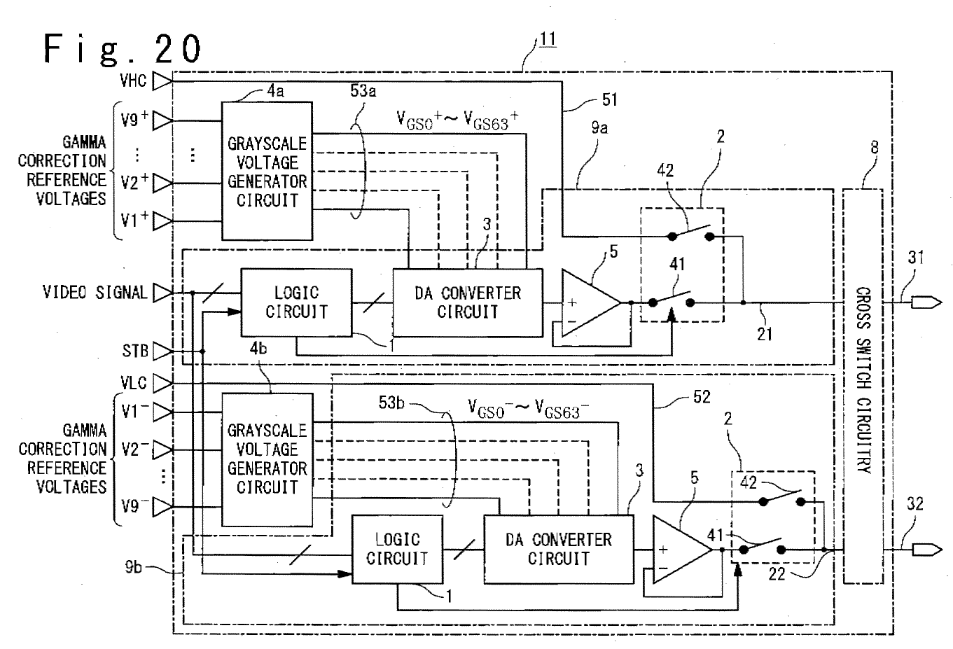

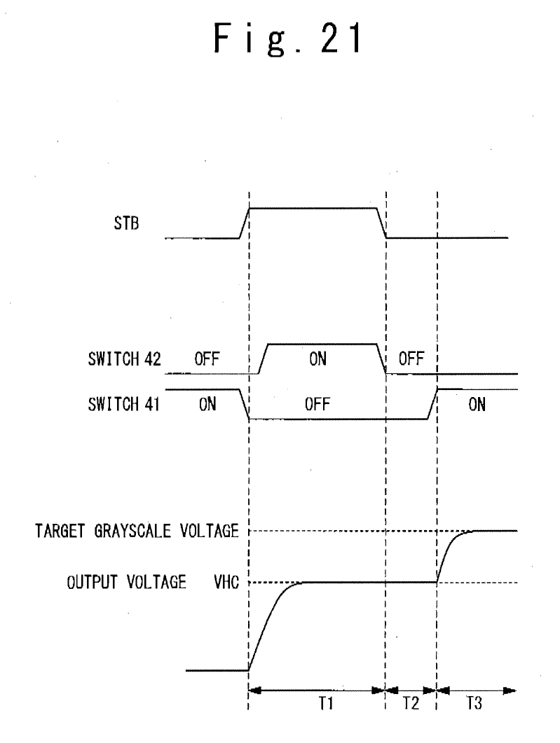

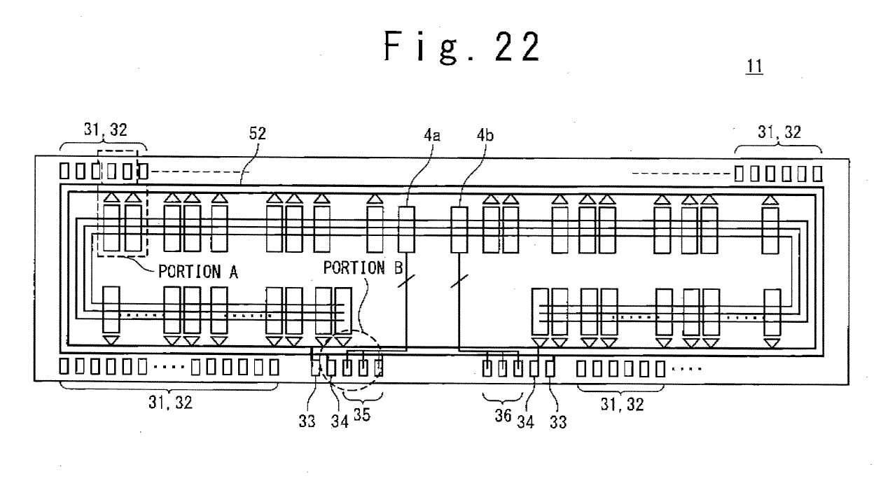

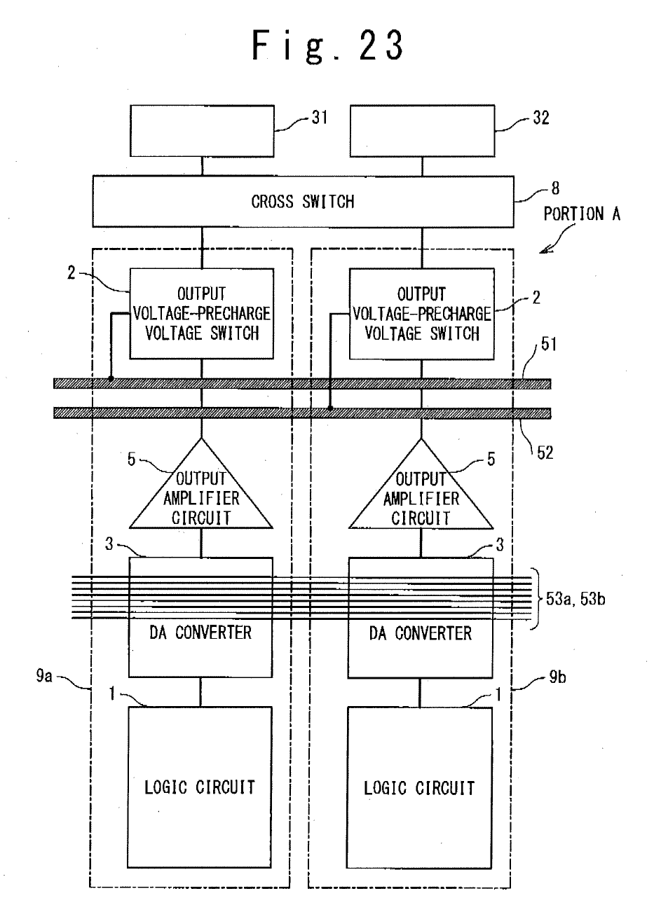

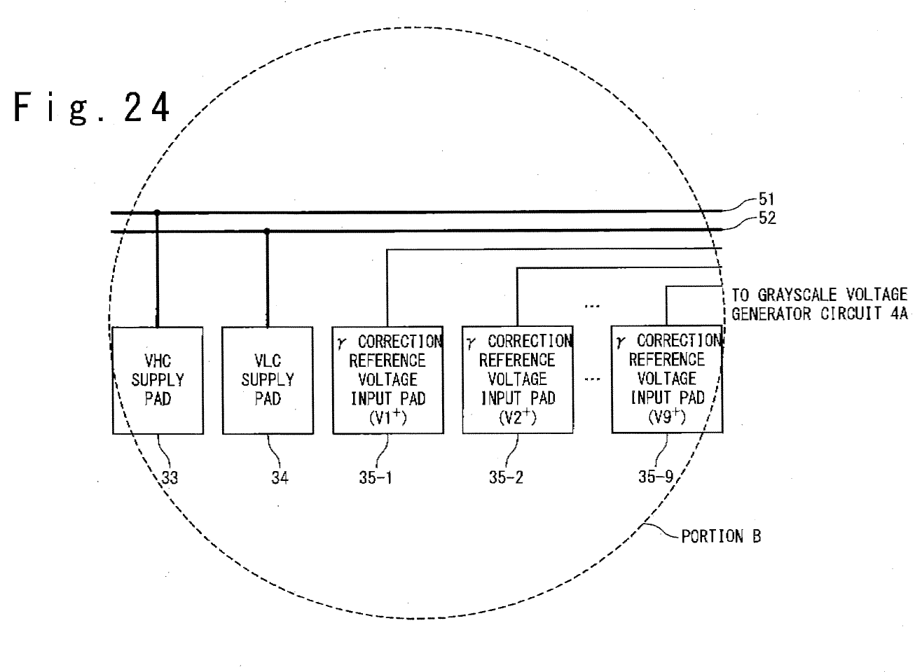

FIG. 1 is a block diagram illustrating portions of a source driver 11 and a liquid crystal panel 6 in a first embodiment of the present invention. It should be noted that the same components as those illustrated in FIGS. 17 to 24 are denoted by the same numerals, in the following.

The source driver 11 of the first embodiment has basically the same configuration as that of the source driver 11 illustrated in FIG. 18, and is applied to the liquid crystal display device illustrated in FIG. 17; the difference is as follows:

First, the source driver 11 of the first embodiment is additionally provided with γ correction reference voltage-precharge switching sections 7a and 7b. The γ correction reference voltage-precharge switching section 7a is connected to the positive grayscale voltage generator circuit 4a, and selects externally supplied positive γ correction reference voltages V1⁺ to V9⁺ and an externally supplied precharge voltage VHC in response to a control signal received from a logic circuit 1 to supply the same to the positive grayscale voltage generator circuit 4a. In this embodiment, the positive grayscale voltage generator circuit 4a and the γ correction reference voltage-precharge switching section 7a constitute a grayscale voltage supplying section that selectively outputs the positive grayscale voltages and the positive precharge voltage. Similarly, a γ correction reference voltage-precharge switching section 7b is connected to a negative grayscale voltage generator circuit 4b, and selects externally supplied negative γ correction reference voltages V1⁻ to V9⁻ and an externally supplied precharge voltage VLC in response to the control signal from the logic circuit 1 to supply the same to the negative grayscale voltage generator circuit 4b. The negative grayscale voltage generator circuit 4b and the γ correction reference voltage-precharge switching section 7b constitute another grayscale voltage supplying section that selectively outputs the negative grayscale voltages and the negative precharge voltage.

A second difference is that some of the lines (grayscale voltage lines) that supply the grayscale voltages from the grayscale voltage generator circuit 4a and 4b to the DA converter circuits 3 (3-1 to 3-N) are connected to the output voltage/precharge voltage switch circuits 2 (2-1 to 2-N). As will be described later, in this embodiment, the precharge voltage VHC and VLC are supplied to, the output voltage/precharge voltage switch circuits 2 through the grayscale voltage lines connected to the output voltage/precharge voltage switch circuits 2.

In a precharging operation, the output voltage/precharge voltage switch circuits 2 place the outputs of the output amplifier circuits 5 into the high impedance state, and outputs the precharge voltages VHC and VLC supplied from the grayscale voltage lines, to the data lines 62 of the liquid crystal panel 6 through a cross switch circuitry 8. On the other hand, in driving the data lines 62 of the liquid crystal panel 6, the grayscale voltages received from the output amplifier circuit 5 are outputted to the corresponding data lines 62 through the cross switch circuitry 8.

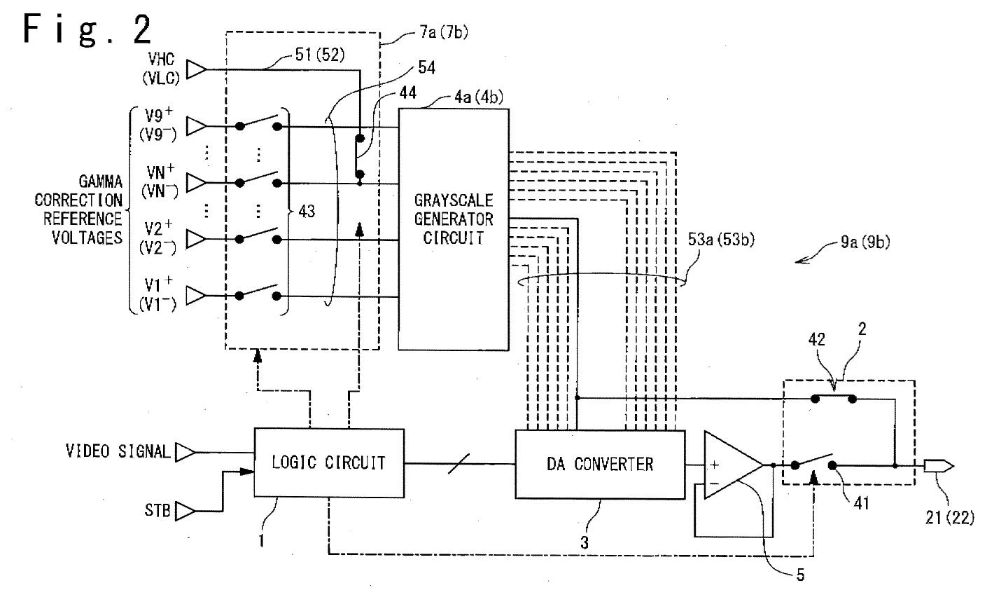

FIG. 2 is a diagram specifically illustrating the configuration of the source driver 11 of the first embodiment. FIG. 2 illustrates configurations of a positive-side drive circuit 9a, the positive grayscale voltage generator circuit 4a, and the γ correction reference voltage-precharge switching section 7a.

The γ correction reference voltage-precharge switching section 7a is provided with: γ correction reference voltage supply lines 54 that externally supply the positive γ correction reference voltages V1⁺ to V9⁺ to the positive grayscale voltage generator circuit 4a; switches 43 respectively inserted in the γ correction reference voltage supply lines 54; and switch 44 used for providing a connection between one of the γ correction reference voltage supply lines 54 and a VHC line 51. Although the output voltage/precharge voltage switch circuit 2 has the switches for switching between the output of the output amplifier circuit 5 and the precharge voltage VHC supplied from the dedicated VHC line 51 in the configuration of FIG. 20, the configuration of this embodiment is different in that a switch 41 is provided between the output of the output amplifier circuit 5 and an input terminal of the cross switch circuitry 8, and a switch 42 is provided between any one of the grayscale voltage lines 53a and the DA converter circuit 3 and the input terminal of the cross switch circuitry 8. It should be noted that the grayscale voltage lines 53a provides connections between the positive grayscale voltage generator circuit 4a.

The switches 43 and 44 of the γ correction reference voltage-precharge switching section 7a and the switches 41 and 42 of the output voltage/precharge voltage switch circuit 2 are subjected to ON/OFF control in response to the control signal from the logic circuit 1.

The negative-side drive block 9b, the negative grayscale voltage generator circuit 4b, and the γ correction reference voltage-precharge switching section 7b have the same configurations except that voltages supplied thereto are different. Specifically, the γ correction reference voltage supply lines 54 of the γ correction reference voltage-precharge switching section 7b are supplied with the negative γ correction reference voltages V1⁻ to V9⁻, and also the switch 44 is connected to the VLC line 52 that supplies the precharge voltage VLC.

Next, a description is given of the operation of the γ correction reference voltage-precharge switching section 7a and 7b, and output voltage/precharge voltage switch circuits 2 is described. In the following, the operation of the γ correction reference voltage-precharge switching section 7a is described; however, one skilled in the art would appreciate that the γ correction reference voltage-precharge switching section 7b also operates in the same manner.

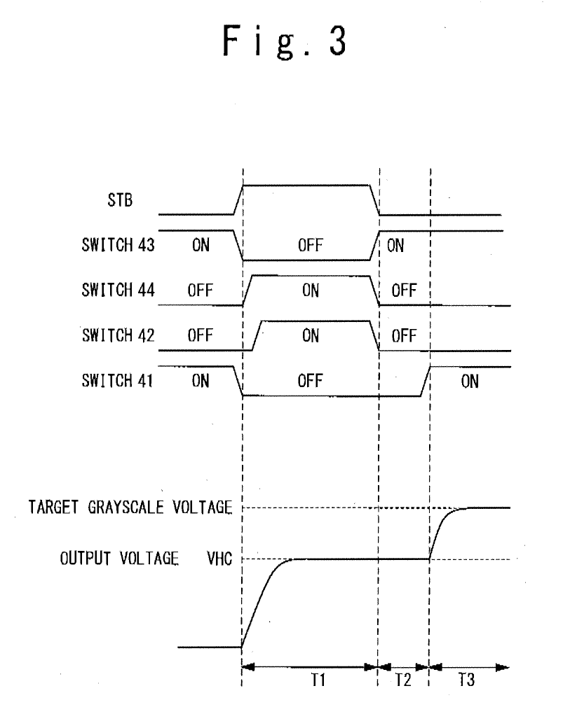

As illustrated in FIG. 3, during precharging in a period T1, the logic circuit 1 performs an on/off control in synchronization with a rise of the strobe signal STB, to turn off the switches 43 of the γ correction reference voltage-precharge switching section 7a and the switch 41 of the output voltage/precharge voltage switch circuit 2 and to turn on the switch 44 of the γ correction reference voltage-precharge switching section 7a and the switch 42 of the output voltage/precharge voltage switch circuit 2. The turn-off of the switches 43 results in stopping supplying the γ correction reference voltages V1⁺ to V9⁺ to the positive grayscale voltage generator circuit 4a, and the turn-on of the switch 44 allows supplying the precharge voltage VHC to the positive grayscale voltage generator circuit 4a through the specific γ correction reference voltage supply line 54. As a result, the precharge voltage VHC is outputted from the grayscale voltage line 53a corresponding to the γ correction reference voltage supply line 54. At this time, the switch 42 is turned on, and the switch 41 is turned off, so that the voltage corresponding to the precharge voltage VHC is outputted from the cross switch input terminal 21 through the switch 42.

Preferably, one of the grayscale voltage lines through which the γ correction reference voltage V1⁺ to V9⁺ are forwarded without a voltage drop is selected as the grayscale voltage line 53a connected to the switch 42. This allows outputting the precharge voltage VHC to the cross switch input terminal 21 without being subjected to a voltage drop across resistors the resistor ladder of the positive grayscale voltage generator circuit 4a. For example, in FIG. 19, the use of the grayscale voltage line through which the γ correction reference voltage V2⁺ is directly outputted as a grayscale voltage V_{GS2}⁺ is preferable. However, it would be apparent to the person skilled in the art that any of the grayscale voltage lines 53a may be used to forward the precharge voltage VHC in view of the operation.

The precharge voltage VHC that is approximately the middle voltage of the highest grayscale voltage and the common level V_{COM} is outputted from the source driver 11, to thereby precharge the corresponding data line 62 of the liquid crystal panel 6.

Subsequently, during a period T2 of FIG. 3, the logic circuit 1 performs an on/off control in synchronization with a fall of the strobe signal STB, to turn on the switches 43 and to turn off the switch 44 and 42; the switch 41 is kept off. This results in that both of the precharge voltage VHC and the grayscale voltage are not outputted, and the cross switch input terminal 21 is in the high impedance state. That is, the period T2 serves as a setup period during which the γ correction reference voltages V1⁺ to V9⁺ are inputted to the positive grayscale voltage generator circuit 4a through the switches 43, and the DA converter circuit 3 selects and fixes the grayscale voltage, which is an analog signal voltage, corresponding to the video signal, which is a digital signal.

Further, in a period T3 after the grayscale voltage has been fixed, the logic circuit 1 turns on the switch 41. The turn-on of the switch 41 allows outputting the selected grayscale voltage from the cross switch input terminal 21, and consequently, the corresponding data line 62 of the liquid crystal panel 6 is driven through the cross switch circuitry 8 up to the target grayscale voltage from the precharge voltage VHC.

The source driver 11 may be configured to be adapted to charge sharing, which is a technique for collecting charges by short-circuiting adjacent data lines 62. The charge sharing is a well known technique, and may be realized by providing a switch (not illustrated) between adjacent data lines 62. The present invention may be applied to such a case.

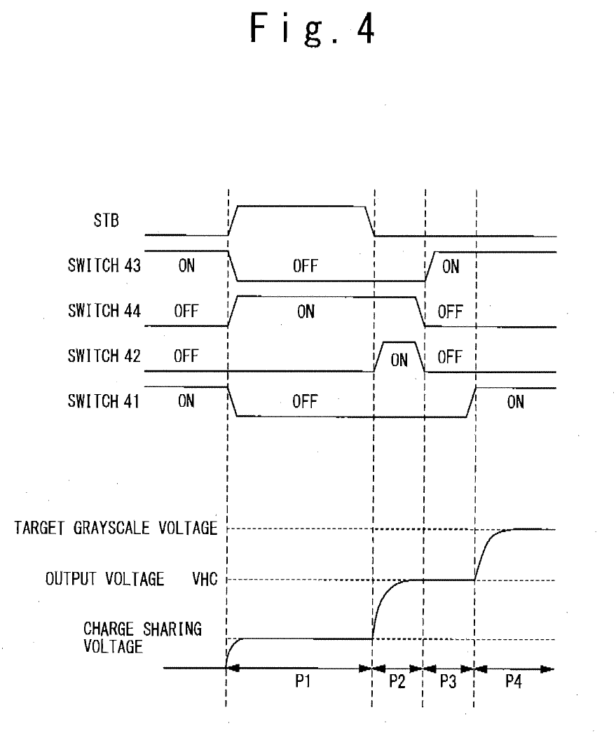

FIG. 4 is a timing chart for a case where the source driver 11 is configured to achieve the charge sharing in which adjacent data lines 62 are short-circuited to collect charges. Although the operation of the γ correction reference voltage-precharge switching section 7a is described similarly to FIG. 3 in the following, one skilled in the art would appreciate that the γ correction reference voltage-precharge switching section 7b also operate in the same manner.

As illustrated in FIG. 4, during a period P1, the logic circuit 1 performs control in synchronization with a rise of the strobe signal STB to turn on the switch 44 and to turn off the switches 43 and 41; the switch 42 is kept off. That is, the period P1 is a charge sharing period during which the adjacent data lines 62 are short-circuited to collect charges.

Subsequently, during a period P2, the logic circuit 1 turns on the switch 42 from the off state at timing when the charge collection is completed; the switches 43 and 41 are kept off and the switch 44 is kept on. The turn-on of the switch 42 allows supplying the precharge voltage VHC outputted from the grayscale voltage generator circuit 4a to the corresponding data line 62 of the liquid crystal panel 6 through the switch 42 and the cross switch circuitry 8 to precharge the corresponding data line 62 to the precharge voltage VHC from the charge sharing voltage.

The operations during periods P3 and P4 are the same as those, during the periods T2 and T3 of FIG. 3 which are previously described. That is, during the period P3 of FIG. 4, the logic circuit 1 turns on the switches 43, and turns off the switches 44, 42, and 41. This results in that none of the precharge voltage VHC and the grayscale voltage is outputted from the output pad 31 or 32, and the cross switch input terminal 21 is placed into the high impedance state. The period P3 serves as a setup period during which the γ correction reference voltages V1⁺ to V9⁺ are inputted to the positive grayscale voltage generator circuit 4a through the switches 43, and the DA converter circuit 3 selects and fixes the grayscale voltage corresponding to the video signal.

Subsequently, during a period P4 after the grayscale voltage is fixed in the DA converter 3, the logic circuit 1 turns on the switch 41. The turn-on of the switch 41 allows outputting the selected grayscale voltage from the cross switch input terminal 21, and consequently, the corresponding data line 62 of the liquid crystal panel 6 is further driven to reach the target grayscale voltage from the precharge voltage VHC.

One advantage of the display device of this embodiment is that dedicated precharge voltage supply lines with a wide width (such as, the VHC line 51 and VLC line 52 in FIGS. 22 and 23) used for supplying the precharge voltages VHC and VLC are not required to be arranged so as to surround the internal circuits such as the respective drive blocks and the grayscale voltage generator circuits 4a and 4b. This effectively eliminates the need for the frame-like extra space of the integrated circuit, reducing the area of the integrated circuit.

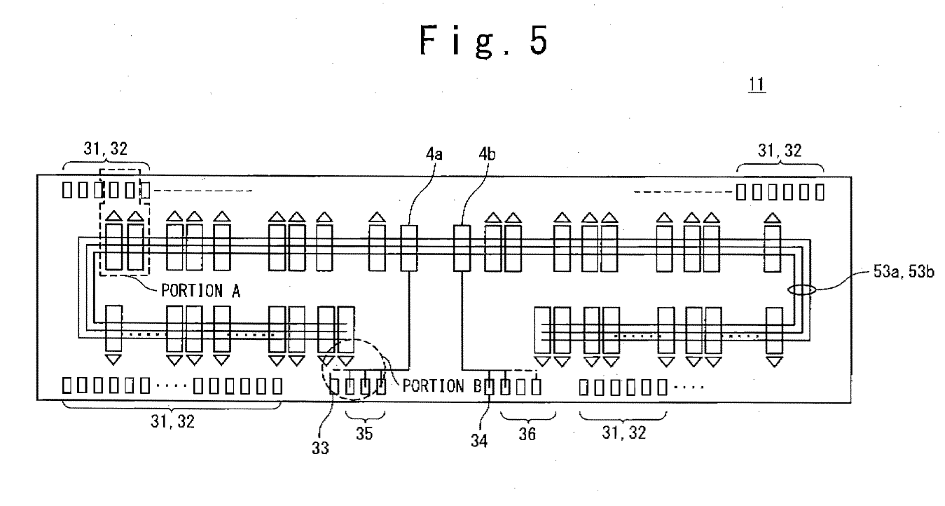

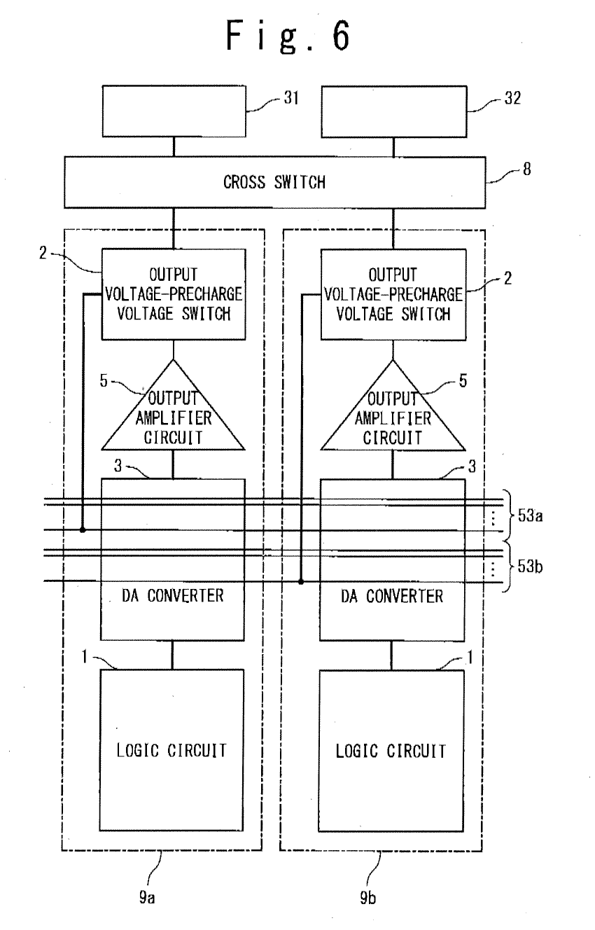

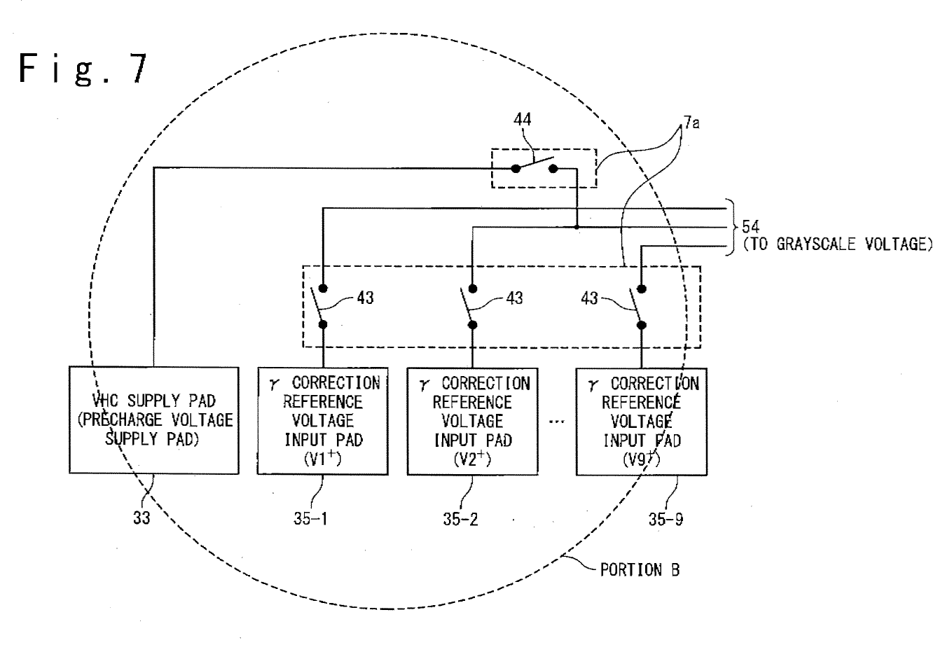

The reason why such an advantage is obtained is described on the basis of schematic diagrams shown in FIGS. 5 to 7, FIG. 5 is the schematic diagram showing the overall configuration of the source driver 11 of FIG. 1. It should be noted that the cross switch circuitry 8 is not illustrated in FIG. 5. The drive blocks 9a and 9b (the logic circuits 1, the DA converter circuits 3, the output amplifier circuits 5, and output voltage/precharge voltage switch circuits 2) are regularly arrayed; the numbers of the drive blocks 9a and 9b are equal to those of the output pads 31 and 32. FIG. 6 is an enlarged view of the part A in FIG. 5, and an arrangement diagram illustrating the circuit arrangement of a pair of drive blocks 9a and 9b in the source driver 11. On the other hand, FIG. 7 is an enlarged view of the part B in FIG. 5, and the schematic diagram illustrating the arrangement of a VHC supply pad 33 that externally receives the precharge voltage VHC and positive γ correction reference voltage pads 35 that externally receive the positive γ correction reference voltages V1⁺ to V9⁺.

FIG. 6 is a conceptual diagram illustrating the arrangement of the pair of drive blocks 9a and 9b in the source driver 11 of FIG. 5 and the corresponding output pads 31 and 32. Among the grayscale voltage lines 53a used for supplying positive grayscale voltages, the grayscale voltage line corresponding to the γ correction reference voltage supply line 54, through which the precharge voltage VHC is supplied, is connected to the output voltage/precharge voltage switch circuit 2 of the positive-side drive block 9a. Similarly, among the grayscale voltage lines 53b used for supplying negative grayscale voltages, the grayscale voltage line corresponding to the γ correction reference voltage supply line 54, through which the precharge voltage VLC is supplied, is connected to the output voltage/precharge voltage switch circuit 2 of the negative-side drive block 9b.

FIG. 7 is the enlarged view of the part B of FIG. 5, and illustrates the portion around the γ correction reference voltage-precharge switching section 7a. The switches 43 of the γ correction reference voltage-precharge switching section 7a are arranged between the positive γ correction reference Voltage pads 35-1 to 35-9 and the γ correction reference voltage supply lines 54. Also, the switch 44 is arranged between the VHC supply pad 33 and the specific γ correction reference voltage supply line 54.

Although not shown in FIG. 7, the person skilled in the art would appreciate that the VLC supply pad 34, which externally receives the precharge voltage VLC, and the negative γ correction reference voltage supply pads 36, which externally receive the γ correction reference voltages V1⁻ to V9⁻, are also arranged in the same manner.

As is understood from FIGS. 5 to 7, in the present embodiment, differently from the circuit arrangement of FIG. 22, the dedicated precharge voltage supply lines with a wide width (the VHC and VLC lines) are not required to be arranged so as to surround the internal circuits such as the drive blocks 9a and 9b and grayscale voltage generator circuits 4a and 4b, which eliminates the frame-like extra space of the integrated circuit, effectively reducing the area of the integrated circuit.

Further, the circuit arrangement in which the frame-like precharge voltage supply lines with a wide width (VHC and VLC lines) are arranged as illustrated in FIG. 22 requires the VHC supply pad 33 and the VLC supply pad 34 to be provided adjacently for each of the positive grayscale voltage generator circuit 4a and the negative grayscale voltage generator circuit 4b, respectively, to provide connections to the VHC line 51 and the VLC line 52 with reduced interconnection impedances. On the contrary, in this embodiment, the frame-like precharge voltage supply lines with a wide width are not required; such arrangement only requires for providing the VHC supply pad 33 only on the side of the positive grayscale voltage generator circuit 4a and the VLC supply pad 34 only on the side of the negative grayscale voltage generator circuit 4b, so that the open space can be used for additional output pads, allows effective use of the area of the integrated circuit.

### Second Embodiment

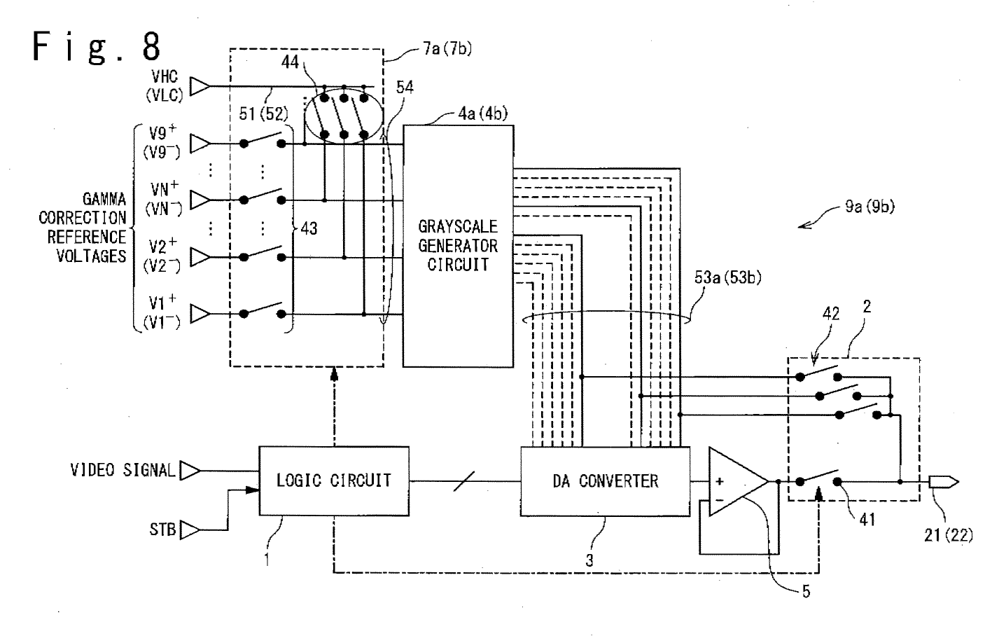

FIG. 8 is a circuit diagram illustrating the configuration of the source driver 11 of the display device in a second embodiment of the present invention. In the configuration of the first embodiment, the interconnection length from the VHC line 51, which supplies the precharge voltage VHC, to the cross switch input terminal 21 may be long, and in such a case, a voltage drop due to the interconnection resistance may cause a problem. The second embodiment is directed to further solve the problem due to the voltage drop.

In the second embodiment, each of the drive blocks 9a and 9b is provided with a plurality of switches 44 in the γ correction reference voltage-precharge switching section 7a, a plurality of switches 42 in an output voltage/precharge voltage switch circuit 2, and a plurality of interconnection lines connected to the switches 42, and two or more of the γ correction reference voltage supply lines 54 and the grayscale voltage lines 53a are used for supplying the precharge voltage VHC. In this case, some of grayscale voltage lines 53a for supplying grayscale voltages within a predetermined voltage range including the precharge voltage are selected as the grayscale voltage lines 53a used for supplying the precharge voltage VHC. It should be noted that, although FIG. 8 illustrates the configuration of the γ correction reference voltage-precharge switching section 7a connected to the positive drive block 9a and the positive grayscale voltage generator circuit 4a, it would be apparent to the person skilled in the art that the γ correction reference voltage-precharge switching section 7b connected to the negative drive block 9b and the negative grayscale voltage generator circuit 4b may be configured in the same manner.

The operation of the source driver 11 of the second embodiment is essentially the same as that of the first embodiment. That is, when precharging is performed, the switches 44 and 42 are turned on, and the lines connected to the switches 44 of the γ correction reference voltage-precharge switching section 7a, the grayscale voltage lines 53a, and the plurality of γ correction reference voltage supply lines 54 are respectively connected in parallel, so that the effective interconnection impedances are considerably reduced.

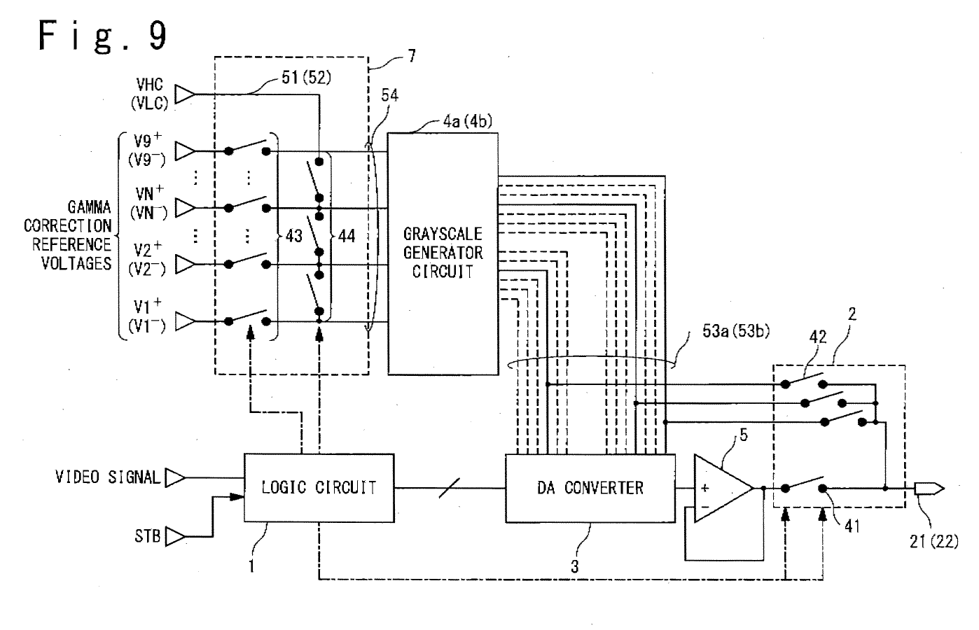

FIG. 9 is a circuit diagram illustrating a configuration of a variation of the source driver in the second embodiment. Although the γ correction reference voltage supply lines 54 and the VHC line 51 are connected in parallel through the switches 44 in the circuit configuration shown in FIG. 8, the γ correction reference voltage supply lines 54 used for supplying the precharge voltage VHC (or VLC) are connected in series in the circuit configuration of FIG. 9. In this circuit configuration, the number of lines branched from a VHC line 51 is reduced, and therefore the area necessary for disposing the interconnection lines can be further reduced.

It should be noted that the precharge voltage VHC can be outputted from the cross switch input terminal 21 without a voltage drop caused by the resistor ladder, when the grayscale voltage lines through which the γ correction reference voltages are fed without a voltage drop are appropriately selected as the grayscale voltage lines 53a connected to the plurality of switches 42.

Also, it would be apparent from FIG. 9 that the switches 42 of the output voltage/precharge voltage switch circuit 2 may be connected in series in the same manner, or the switches 44 and the switches 42 may be respectively connected in series. It should be noted that although FIG. 9 illustrates the configuration in which the γ correction reference voltage-precharge switching section 7a is connected to a positive-side dive block 9a and the positive grayscale voltage generator circuit 4a, it would be apparent to the person skilled in the art that the γ correction reference voltage-precharge switching section 7b connected to the negative-side drive block 9b and the negative grayscale voltage generator circuit 4b may be configured in the same manner.

### Third Embodiment

FIG. 10 is a circuit diagram illustrating a configuration of a source driver 11 in a third embodiment of the present invention. In the first and second embodiments, the precharge voltage VHC is supplied through the switch(es) 44 of the γ correction reference voltage-precharge switching section 7a and the switch(es) 42 of the output voltage/precharge voltage switch circuit 2; however, in the third embodiment, VHC applied grayscale voltage selection circuits 45 and 46 are provided in place of the switches 44 and 42. The VHC applied grayscale voltage selection circuit 45 of the γ correction reference voltage-precharge switching section 7a arbitrarily selects one of γ correction reference voltage supply lines 34 to be connected to the VHC line 51 supplied with the precharge voltage VHC, whereas the VHC applied grayscale voltage selection circuit 46 of the output voltage/precharge voltage switch circuit 2 provides a connection between the grayscale voltage line in charge of supplying the precharge voltage VHC and the cross switch input terminal 21.

Such configuration aims to use charges more effectively to thereby reduce the power consumption, by using, when the externally supplied precharge voltage V1-IC is close to a specific γ correction reference voltage, the γ correction reference voltage supply line 54 supplying the γ correction reference voltage and the grayscale voltage line 53a corresponding thereto for supplying the precharge voltage VHC. In particular, this configuration is effective for a case where the precharge voltage VHC should be changed in accordance with changes in the specifications of the liquid crystal panel 6. The control signal from the logic circuit 1 may be used as a method for the selection.

Also the numbers of the γ correction reference voltage supply lines 54 and the grayscale voltage lines 53a to be selected are not limited to one; similarly to the second embodiment, two or more of the γ correction reference voltage supply lines 54 and corresponding grayscale voltage lines 53 may be selected. For example, in a case where the voltage level of the precharge voltage VHC is between γ correction reference voltages Vn⁺ and Vm⁺, the use of the γ correction reference voltage supply line 54 supplying the γ correction reference voltage Vn⁺ or Vm⁺ and the corresponding grayscale voltage line 53a for supplying the precharge voltage VHC effectively reduces the power consumption and the voltage drop due to the interconnection resistance. Also, it would be appreciated that a γ correction reference voltage supply line 54 adjacent to the above-mentioned γ correction reference voltage supply line 54 and a grayscale voltage line 53 adjacent to the above-mentioned grayscale voltage line 53a may be used to supply the precharge voltage VHC.

It should be noted that although FIG. 10 illustrates the configuration of the γ correction reference voltage-precharge switching section 7a connected to the positive-side drive block 9a and the positive grayscale voltage generator circuit 4a, it would be apparent to the person skilled in the art that the γ correction reference voltage-precharge switching section 7b connected to the negative-side drive block 9b and the negative grayscale voltage generator circuit 4b may be configured in the same manner.

As described above, the source driver 11 of this embodiment supplies the precharge voltage VHC or VLC by using one or more γ correction reference voltage supply lines 54 that supply the externally inputted γ correction reference voltages V1⁺ to V9⁺ or V1⁻ to V9⁻ to the grayscale voltage generator circuit 4a or 4b, and the grayscale voltage lines 53a or 53b, so that the arrangement configuration of the integrated circuit can be simplified and the area of the integrated circuit can be reduced.

That is, the γ correction reference voltage supply lines 54 and the grayscale voltage lines 53a and 53b are selectively used depending on the operation timing of each of the application of the pre-charge voltage VHC or VHL and the output of the grayscale voltage, and this eliminates the need for providing a dedicated precharge voltage supply line, so that the interconnections within the integrated circuit can be simplified and the area can be reduced.

Also, when the voltage level of the externally supplied precharge voltage VHC and VLC are close to specific γ correction reference voltages, the architecture of the third embodiment allows efficiently use charges and thereby reducing the power consumption by using the γ correction reference voltage supply lines 54 supplied with those γ correction reference voltages, and the corresponding grayscale voltage line 53a and 53b to supply the precharge voltage. This applies to a case where the specifications of the liquid crystal panel 6 are changed.

### Fourth Embodiment

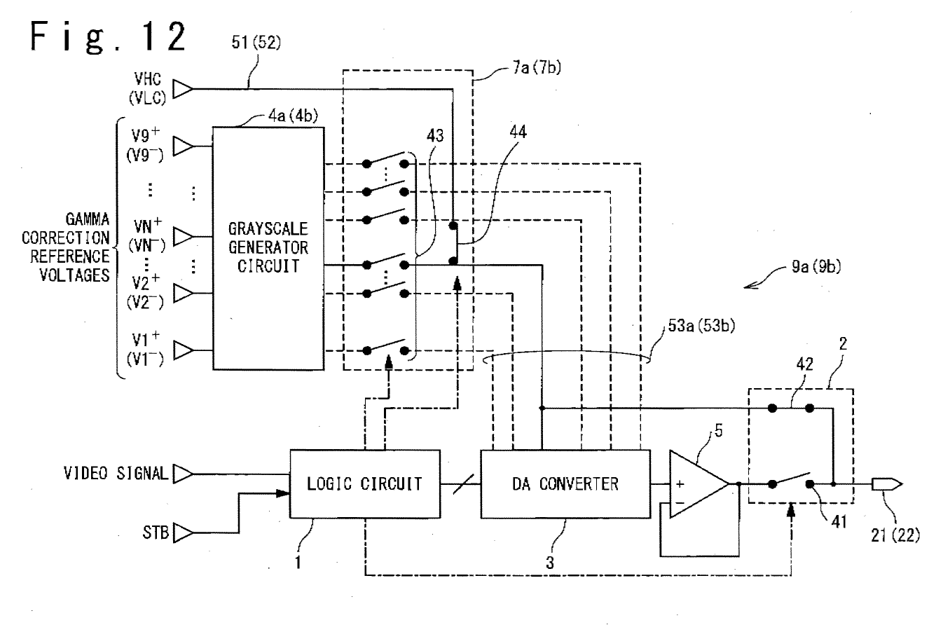

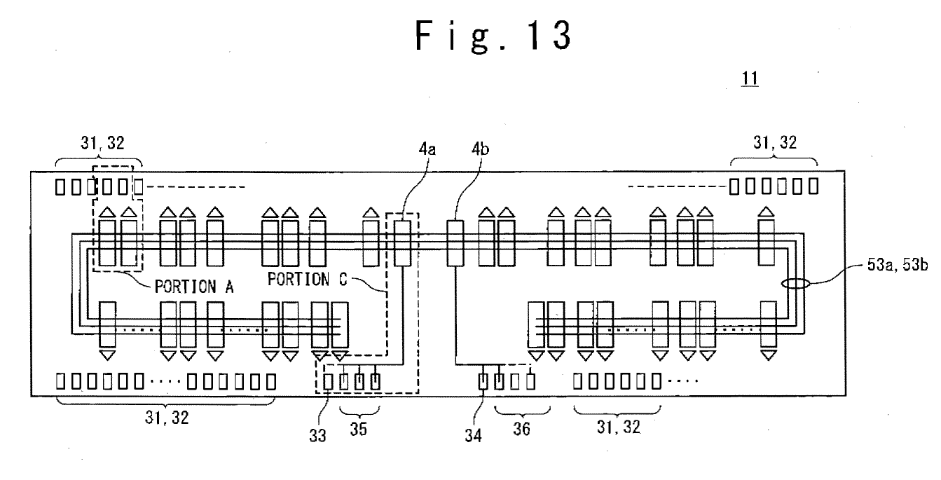

FIG. 11 is a block diagram illustrating configurations of the source driver 11 and the liquid crystal panel 6 in a fourth embodiment of the present invention, and FIG. 12 is a circuit diagram illustrating configurations of the γ correction reference voltage-precharge switching section 7a and the output voltage/precharge voltage switch circuit 2 in the fourth embodiment.

In the fourth embodiment, the γ correction reference voltage-precharge switching section 7a and 7b are arranged between the outputs of the grayscale voltage generator circuits 4a and 4b and the DA converter circuits 3. It should be noted that, in the first to third embodiment, the γ correction reference voltage-precharge switching sections 7a and 7b are provided between the γ correction reference voltage pads 35 and 36 and the inputs of the grayscale voltage generator circuit 4a and 4b. The essential function of the γ correction reference voltage-precharge switching section 7a and 7h is to sever the γ correction reference voltage supply lines 54 and the grayscale voltage lines 53a and 53b, and to use the severed lines to feed the precharge voltage VHC, and therefore the γ correction reference voltage-precharge switching section 7a and 7b may be arranged between the output of the grayscale voltage generator circuit 4a or 4b and the DA converter circuits 3.

It should be noted that although FIG. 12 illustrates the configuration in which the γ correction reference voltage-precharge switching section 7a is connected to a positive-side drive block 9a and the positive grayscale voltage generator circuit 4a; it would be apparent to the person skilled in the art that the γ correction reference voltage-precharge switching section 7h connected to a negative-side drive block 9b and the negative grayscale voltage generator circuit 4b may be configured in the same manner.

Next, a description is given of an example of the circuit arrangement for a case where the source driver 11 of the fourth embodiment is integrated within an integrated circuit with use of schematic diagrams. FIG. 13 is a schematic diagram showing the overall configuration of the source 11 of FIG. 11. It should be noted that the cross switch circuitry 8 is not illustrated in FIG. 13. The drive blocks 9a and 9b (logic circuits 1, DA converter circuits 3, output amplifier circuits 5, output voltage/precharge voltage switch circuiting parts 2) are regularly arrayed, and the number of the drive blocks 9a and 9b are equal to the numbers corresponding to the numbers of output pads 31 and 32.

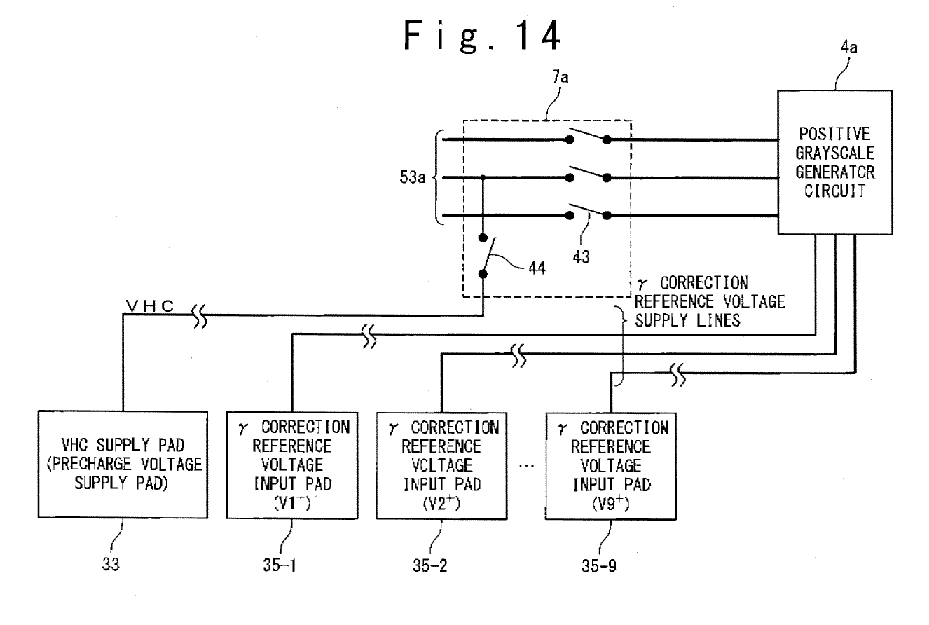

FIG. 14 is a schematic diagram of the part C in FIG. 13, which illustrates the circuit arrangement of the VHC supply pad 33, the positive γ correction reference voltage pads 35, positive grayscale voltage generator circuit 4a and the γ correction reference voltage-precharge switching section 7a. It should be noted that the enlarged view of the part A in FIG. 13 is the same as the above-described enlarged view of the part A in FIG. 6.

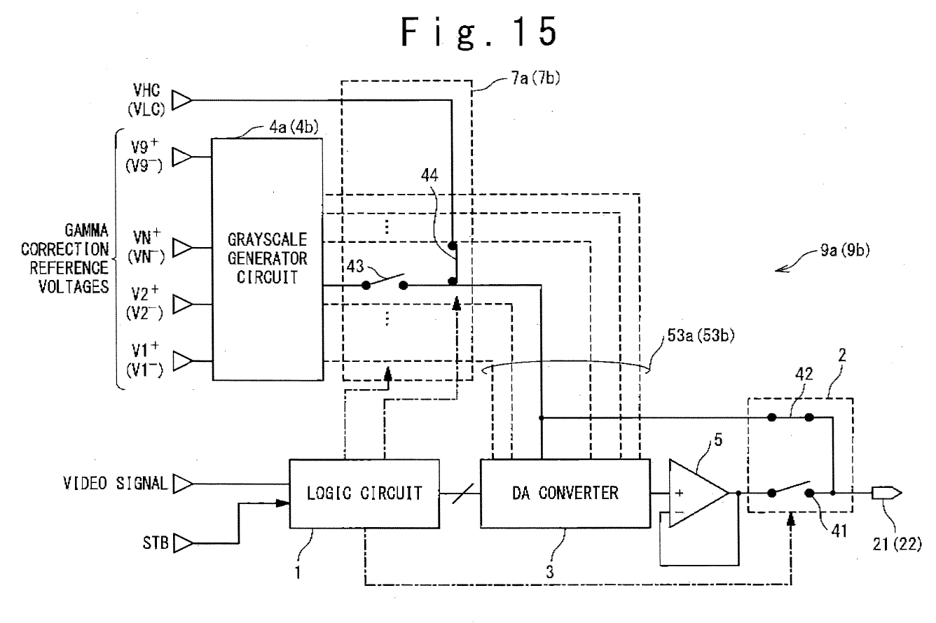

FIG. 15 is a circuit diagram illustrating a configuration of a variation of the source driver 11 in the fourth embodiment of the present invention. As in the fourth embodiment, in a case where the γ correction reference voltage-precharge switching section 7a is arranged between the output of the positive grayscale voltage generator circuit 4a and the DA converter circuits 3, it is not necessary to sever all of the grayscale voltage lines 53a when the precharge voltage is applied. That is, if only at least a grayscale voltage line(s) 53a applying the precharge voltage is severed and the other grayscale voltage lines are applied with grayscale voltages, this achieves desired operations; the outputs of the DA converter circuits 3 are interrupted by the output voltage/precharge voltage switch circuit 2 even if the grayscale voltages are inputted to the DA converter circuits 3. Therefore, in the configuration of FIG. 15, multiple switches 43 of the γ correction reference voltage-precharge switching section 7a are not provided for the respective grayscale voltage lines 53a; one switch 43 and one switch 44 are provided only for the grayscale voltage line used to supply the precharge voltage. Further, the switches 43 and 44 may be configured as one switch element. This variation of the fourth embodiment effectively reduces the number of switches, and further achieves simplification of the arrangement configuration, reduction in the area of the integrated circuit, and reduction in power consumption. It should be appreciated that, even in this case, the number of grayscale voltage lines for applying the precharge voltage is not limited to one; a plurality of grayscale voltage lines may be simultaneously switched. Also, it would be apparent to the person skilled in the art that the configuration of FIG. 15 may be applied to the negative grayscale voltage generator circuit 4b, the γ correction reference voltage-precharge switching section 7b, and the negative-side drive block 9b.

Further, another variation of the fourth embodiment is illustrated in FIG. 16.

In the configuration of FIG. 16, the switches 43 of the γ correction reference voltage-precharge switching section 7a are provided on the input side of the positive grayscale generation circuit 4a, i.e., inserted into the γ correction reference voltage supply lines 54, and the switch 44 is provided on the output side of the positive grayscale voltage generator circuit 4a, i.e., inserted into one of the grayscale voltage lines 53a. This further enhances the simplification and degree of freedom of the arrangement configuration of the integrated circuit, further allowing reduction of the area. Also, similarly to FIG. 15, it would be apparent to the person skilled in the art that the configuration of FIG. 16 can be applied to the negative grayscale voltage generator circuit 4b, the γ correction reference voltage-precharge switching section 7b, and the negative-side drive block 9b.

Although embodiments of the present invention are described in detail in the above; it would be apparent to the person skilled in the art the present invention is not limited to the above embodiments, but may be modified and changed without departing from the scope of the invention. Especially, although the present invention is described as being applied to the drive circuit for the liquid crystal display device, it would be appreciated that the present invention is not limited to the liquid crystal display device but may be applied to drive circuits for other display devices.

What is claimed is:

1. A drive circuit for driving data lines of a display panel in a display device, comprising:
grayscale voltage lines;
a grayscale voltage supplying section receiving a plurality of reference voltages and a precharge voltage, and configured to output a plurality of grayscale voltages generated from said plurality of reference voltages to said plurality of grayscale voltage lines, respectively, and to selectively supply said precharge voltage to at least one of said grayscale voltage lines;
a DA converter circuit receiving said plurality of grayscale voltages, selecting one of said plurality of grayscale voltages in response to a video signal, and outputting said selected grayscale voltage;
an output voltage/precharge voltage switch circuit configured to selectively output said grayscale voltage received from said DA converter circuit or said precharge voltage received from said at least one grayscale voltage line, to corresponding one of said data lines of said display panel.

2. The drive circuit according to claim 1, wherein said grayscale voltage supplying section includes:
a plurality of reference voltage supply lines receiving said plurality of reference voltages, respectively;
a switch circuitry configured to supply said precharge voltage to at least one of said plurality of reference voltage supply lines; and
a grayscale voltage generator circuit configured to generate said plurality of grayscale voltages from said plurality of reference voltages received from said plurality of reference voltage supply lines and to output said plurality of grayscale voltages generated therein to said plurality of grayscale voltage lines, respectively, and
wherein said precharge voltage is supplied from said at least one reference voltage supply line to said at least one grayscale voltage line.

3. The drive circuit according to claim 2,
wherein said grayscale voltage generator circuit generates said plurality of grayscale voltages by voltage division of said plurality of reference voltages with a resistor ladder, and
wherein said at least one grayscale voltage line is selected so that a reference voltage supplied to said at least one reference voltage supply line is outputted as said precharge voltage to said at least one grayscale voltage line without a voltage drop.

4. The drive circuit according to claim 1,
wherein said at least one grayscale voltage line includes a plurality of lines.

5. The drive circuit according to claim 1, wherein said
wherein said at least one grayscale voltage line includes a plurality of lines,
wherein said grayscale voltage supplying section includes:
a plurality of reference voltage supply lines receiving said plurality of reference voltages, respectively;
a switch circuitry supplying said precharge voltage to a plurality of selected supply lines out of said plurality of reference voltage supply lines; and
a grayscale voltage generator circuit configured to generate said plurality of grayscale voltages from said plurality of reference voltages received from said plurality of reference voltage supply lines, respectively, and to output said plurality of plurality of grayscale voltage generated therein to said plurality of grayscale voltage lines, respectively, and
wherein said precharge voltage is supplied from said plurality of selected supply lines to said plurality of lines.

6. The drive circuit according to claim 5, wherein said switch circuitry includes a plurality of switches connected in parallel between a precharge voltage supply line and said plurality of selected supply lines, said precharge voltage supply line being supplied with said precharge voltage.

7. The drive circuit according to claim 5, wherein said switch circuitry includes a plurality of switches connected in series, and
wherein each of said plurality of switches is connected between two of said precharge voltage supply line and said plurality of selected supply lines.

8. The drive circuit according to claim 1, wherein said grayscale voltage supply section includes:
a plurality of reference voltage supply lines receiving said plurality of reference voltages, respectively;
a grayscale voltage generator circuit configured to generate said plurality of grayscale voltages from said plurality of reference voltages received from said plurality of reference voltage supply lines; and
a switch circuitry inserted into said at least one grayscale voltage line, and
wherein said switch circuitry exclusively performs an operation to supply a grayscale voltage(s) to said DA converter circuit through said at least one grayscale voltage line and an operation to supply said precharge voltage to said output voltage/precharge voltage switch circuit through said at least one grayscale voltage line.

9. The drive circuit according to claim 1, wherein said grayscale voltage supply section includes:
a plurality of reference voltage supply lines receiving said plurality of reference voltages, respectively;
a grayscale voltage generator circuit configured to generate said plurality of grayscale voltages from said plurality of reference voltages received from said plurality of reference voltage supply lines;
a first switch circuitry inserted into said plurality of reference voltage supply lines; and
a second switch circuitry configured to supply said precharge voltage to said at least one grayscale voltage line out of said plurality of grayscale voltage lines,
wherein said first and second switch circuitries exclusively perform an operation to supply said plurality of reference voltages to said grayscale voltage generator circuit through said plurality of reference voltage supply lines and an operation to supply said precharge voltage to said output voltage/precharge voltage switch circuit through said at least one grayscale voltage line.

10. A display device, comprising:
a display panel including pixels arranged in rows and columns;
a display controller supplying a video signal;
a power supply circuit supplying a plurality of reference voltages;
a gate driver supplying scan signals to gate lines of said display panel; and
a drive circuit responsive to said video signal for driving data lines of said display panel,
wherein said drive circuit includes:
grayscale voltage lines;
a grayscale voltage supplying section receiving said plurality of reference voltages and a precharge voltage and configured to output a plurality of grayscale voltages generated from said plurality of reference voltages to said plurality of grayscale voltage lines, respectively and to selectively supply said precharge voltage to at least one of the respective grayscale voltage lines;
a DA converter circuit receiving said plurality of grayscale voltages, selecting one of said plurality of grayscale voltages in response to said video signal and outputting said selected grayscale voltage;
an output voltage/precharge voltage switch circuit configured to selectively output said grayscale voltage received from said DA converter circuit or said precharge voltage received from said at least one grayscale voltage line, to corresponding one of said data lines of said display panel.
